(19) United States
(12) Patent Application Publication
(10) Pub. No.: US 2015/0314708 A1
(43) Pub. Date: Nov. 5, 2015

(54) PUMPING DEVICE FOR VEHICLE SEAT

(71) Applicant: DAS CO., LTD., Gyeongju-si Gyeongsangbuk-do (KR)

(72) Inventor: Jae Ho Kim, Gyeongsangbuk-do (KR)

(73) Assignee: DAS Co., Ltd, Gyeongsangbuk-do (KR)

(21) Appl. No.: 14/647,922

(22) PCT Filed: Nov. 29, 2013
(86) PCT No.: PCT/KR2013/010979

§ 371 Date: May 28, 2015

(30) Foreign Application Priority Data
Nov. 29, 2012 (KR) 10-2012-0137057

(51) Int. Cl. B60N 2/16; F15B 21/00; B23K 26/20

(52) U.S. Cl. CPC B60N 2/1635; B23K 26/20; F15B 21/00

(57) ABSTRACT

Disclosed herein is a pumping device for a vehicle seat including a housing accommodating components therein, the components transferring power to a link means for adjusting a height of a seat cushion, and a cover plate welded and coupled to an opened rear of the housing. Consequently, deformation of the housing is prevented even though the housing has a thin thickness, and thus the pumping device has improved durability.

### TECHNICAL FIELD

The present invention relates to a pumping device for a vehicle seat, capable of adjusting a height of a seat and maintaining the adjusted height in such a manner that a user operates a link means of a seat cushion with operating force.

### BACKGROUND ART

In general, a driver seat, an occupant seat, and seats as other occupant seats, which are installed in front of and behind the interior of a vehicle, have various comfort devices for convenience of occupants.

The comfort devices have a sliding function of adjusting forward and rearward pushing/pulling of the seat, a reclining function of adjusting an inclination of a backrest, etc., according to body types of the occupants.

In addition, a vehicle, which is recently developed or has a predetermined reference or more, also includes a pumping device having a seat cushion lifting function of adjusting a height of a seat cushion 10 by receiving input from a handle lever 20 so as to be suitable for occupants, as illustrated in FIG. 1.

The pumping device is largely configured of a lever unit, a clutch unit, and a brake unit. The lever unit receives operating force of a user and transfers the operating force to the clutch unit. The clutch unit serves to transfer the input operating force (rotational force) of the user to a link means of the seat cushion 10. The brake unit serves to cut off power input in reverse so as to fix the link means an operation of which is completed.

The lever unit includes a lever bracket which converts vertical operating force of the handle lever 20 installed at one side of the seat cushion 10 into rotational force and transfers the rotational force to the clutch unit.

An output member, which finally transfers the operating force transferred from the clutch unit to the link means of the seat cushion 10, is fixed by the brake unit after the operation of the user is completed, thereby restricting the output member from rotating by torque input in reverse.

As a specific example of the pumping device, there is a pumping device disclosed in Korean Patent No. 10-1117794.

The pumping device disclosed in the above patent includes a clutch unit A, a brake unit B, a housing 31 accommodating the same therein, and a cover plate 32 coupled to the rear of the housing 31 so as to close an inner space of the housing 31.

When torque input in reverse is applied to an output member from a link means of a seat cushion 10 in the conventional pumping device, large force acts on an inner peripheral surface of the housing 31 in the radial direction thereof by an inclined surface of the output member and a roller member included in the brake unit B.

In this case, brake strength required for the brake unit B is not exhibited since the housing 31 is rapidly deformed when the housing 31 has a thin thickness. On the other hand, when the housing 31 has a thick thickness, increases in cost and volume of the device are caused.

### DISCLOSURE

### Technical Problem

Accordingly, the present invention has been made in view of the above-mentioned problems, and an object thereof is to provide a pumping device for a vehicle seat, in which a housing is not deformed and is securely supported even though large force acts on an inner peripheral surface of the housing by reverse input torque applied to an output member.

### Technical Solution

In accordance with an aspect of the present invention, a pumping device for a vehicle seat, includes a housing accommodating components therein, the components transferring power to a link means for adjusting a height of a seat cushion, and a cover plate welded and coupled to an opened rear of the housing.

In the pumping device according to the aspect of the present invention, the cover plate may be coupled to the housing in such a manner that the cover plate is inserted in the opened rear of the housing and welding is performed between an edge of the cover plate and an inner peripheral surface of the housing.

In the pumping device according to the aspect of the present invention, the cover plate may have an outer diameter which is equal to an inner diameter of the opened rear of the housing.

In the pumping device according to the aspect of the present invention, the welding may be performed on the entirety of the edge of the cover plate.

In the pumping device according to the aspect of the present invention, the welding may be performed on portions spaced along the edge of the cover plate.

In the pumping device according to the aspect of the present invention, the spaced welded portions may be formed at positions facing each other in a radial direction of the cover plate.

In the pumping device according to the aspect of the present invention, the welding may be performed by a laser welding method.

Additional advantages, objects, and features of the invention will be set forth in part in the description which follows and in part will become apparent to those having ordinary skill in the art upon examination of the following or may be learned from practice of the invention.

### BRIEF DESCRIPTION OF DRAWINGS

The above and other objects, features and other advantages of the present invention will be more clearly understood from the following detailed description taken in conjunction with the accompanying drawings, in which:

FIG. 1 is a view illustrating a vehicle seat;

FIG. 2 is a cross-sectional view illustrating a conventional pumping device;

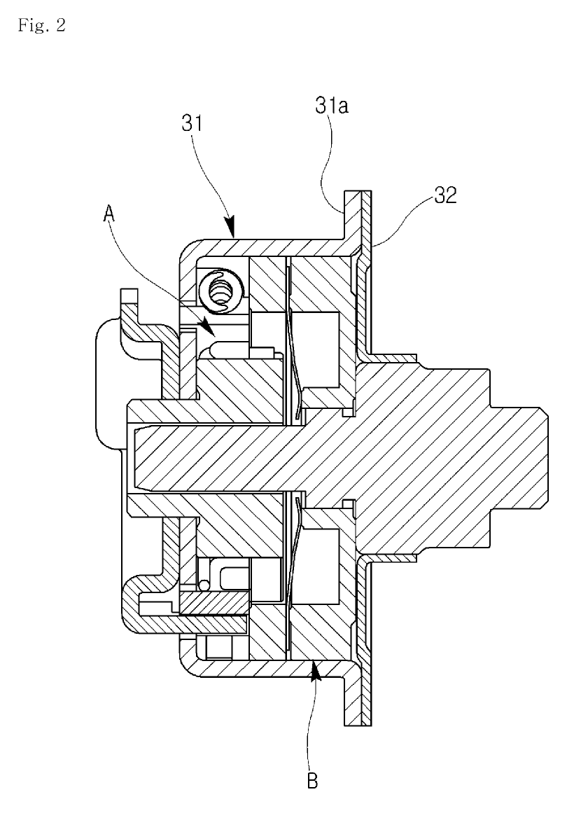

FIG. 3 is an exploded perspective view illustrating a pumping device according to an embodiment of the present invention;

FIG. 4 is a side view illustrating the pumping device according to the embodiment of the present invention; and

FIG. 5 is a back view illustrating the pumping device according to the embodiment of the present invention.

### BEST MODE FOR INVENTION

Hereinafter, a pumping device for a vehicle seat according to exemplary embodiments of the present invention will be described in detail with reference to the accompanying drawings.

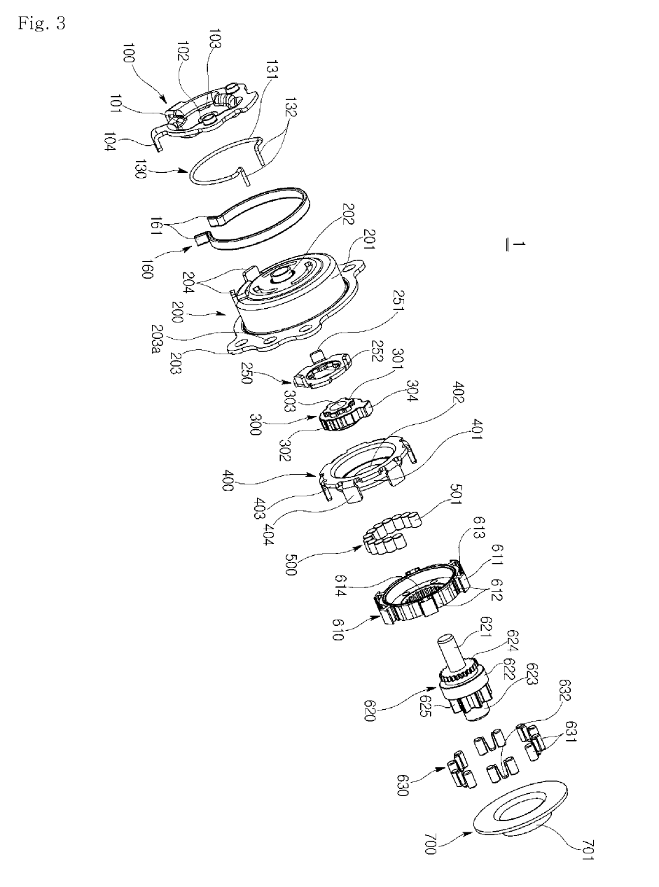

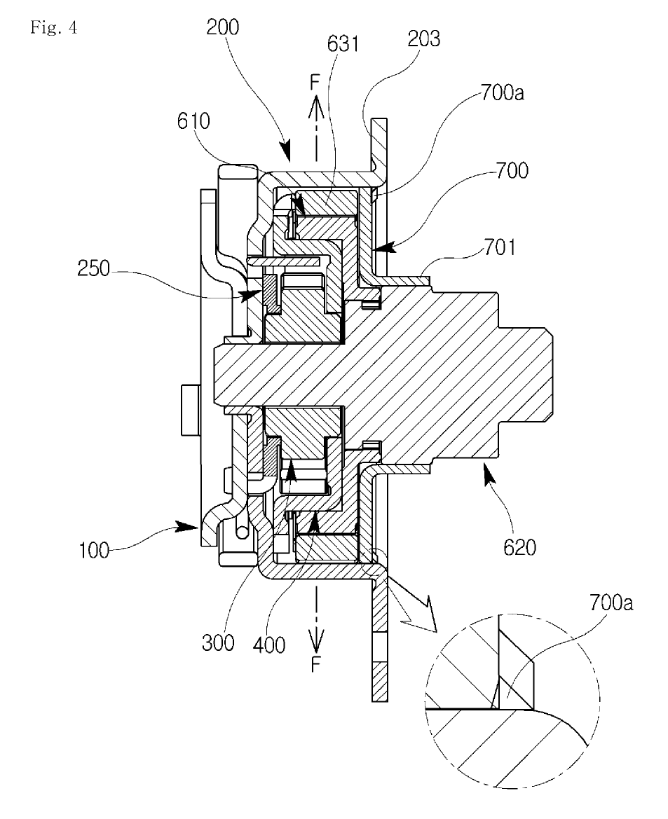

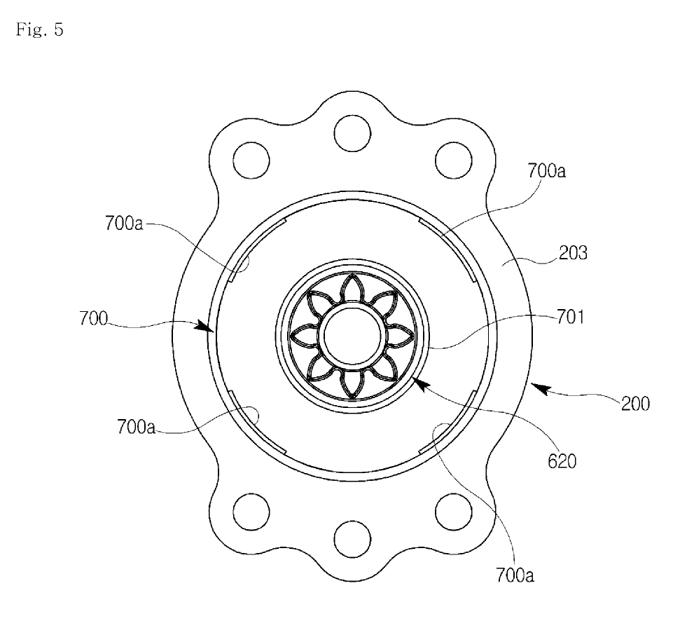

FIG. 3 is an exploded perspective view illustrating a pumping device according to an embodiment of the present invention. FIG. 4 is a side view illustrating the pumping device according to the embodiment of the present invention. FIG. 5 is a back view illustrating the pumping device according to the embodiment of the present invention.

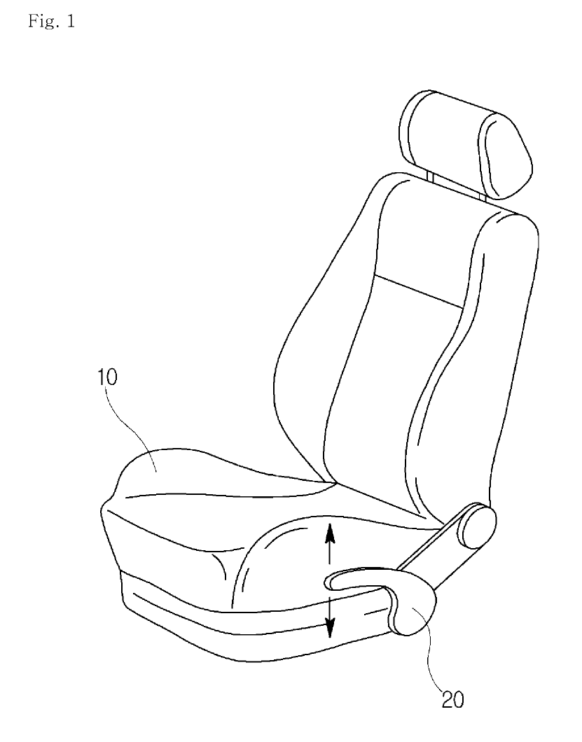

As illustrated in FIGS. 3 to 5, the pumping device for a vehicle seat according to the embodiment of the present invention, which is designated by reference numeral 1, includes a housing 200 which accommodates components therein, the components transferring power to a link means for adjusting a height of a seat cushion 10 (see FIG. 1), and a cover plate 700 which is welded and coupled to the opened rear of the housing 200.

First, a vehicle may include the link means (not shown) for adjusting the height of the seat cushion 10. The link means may adjust the height of the seat cushion 10 by power transferred from the outside, and may be connected to various components for transferring the power to the link means.

For example, one of the components for transferring the power to the link means of the seat cushion 10 may be a clutch means for transferring the power transferred from the outside to the link means. In addition, the pumping device may further include a brake means for selectively restricting the operation of the link means of the seat cushion 10 when the link means completes the height adjustment of the seat cushion 10, in addition to the clutch means.

As the clutch means and the brake means, various clutch means and brake means may be applied, such as the clutch means and the brake means having a specific example described below and the known the clutch means and brake means included in the pumping device for a vehicle seat.

Hereinafter, a specific example of the clutch means and the brake means and a specific coupling structure of the clutch means, the brake means, and the housing included in the embodiment will be described in order to help understanding of the present invention. However, it is understood that the above components and the coupling structure between the components and the housing are not limited to the specific embodiments.

The housing 200 may accommodate components therein. Here, the components may serve to transfer power to the link means of the seat cushion 10 as described above. The link means of the seat cushion 10 may adjust the height of the seat cushion 10 by the power transferred from the components.

The housing 200 may be fixed to the seat cushion 10. The housing 200 may have a space formed therein, and have a shape in which the front thereof is closed and the rear thereof is opened. The housing 200 may include, for example, a cylindrical body portion 201 and a flange portion 203 which extends radially from an outer peripheral surface at the opened rear of the body portion 201, as illustrated in the drawings.

The body portion 201 may have a shaft coupling portion 202 formed at a center of a front surface thereof such that a tip portion of an output shaft 620 to be described later is rotatably coupled through the shaft coupling portion 202. The shaft coupling portion 202 may have a hole formed therein such that the tip portion of the output shaft 620 is coupled through the hole, and have a cylindrical shape protruding forward from the front surface of the body portion 201. The shaft coupling portion 202 may pass through a coupling hole 102 of a lever bracket 100 to be described later and allow the lever bracket 100 to be arranged and supported on the same axis as that of the output shaft 620. The shaft coupling portion 202, for example, the front surface of the body portion 201 may be formed through a burring process.

The body portion 201 may have a plurality of guide slots 201a formed on the front surface thereof, and the guide slots 201a may be circumferentially spaced apart from each other about the shaft coupling portion 202. An example in which three guide slots 201 are formed is illustrated in the drawings.

First, a torque transfer portion 500 to be described later may be provided with elastic force so as to be returned and rotated. An elastic means may be used to provide the elastic force to the torque transfer portion 500. As a specific example of the elastic means, there is proposed a clutch spring 130 including a ring-shaped main body portion 131 and a pair of bending portions 132 bent from both end portions of the main body portion 131, as illustrated in the drawings.

The bending portions 132 of the clutch spring 130 may pass through any one (hereinafter, referred to as “first guide slot”) of the three guide slots 201a. Respective end portions of the bending portions 132 come into contact with both end portions of the torque transfer portion 500 so as to transfer the elastic force to the torque transfer portion 500.

Specifically, one of the bending portions 132 is pushed and moved by one end portion of the torque transfer portion 500 according to rotation of the torque transfer portion 500. In this case, the moving bending portion 132 may be guided in a longitudinal direction of the first guide slot.

Since the other of the bending portions 132 is supported by an end of the first guide slot so as not to move, the clutch spring 130 generates restoring force when the bending portions 132 are close to each other. The restoring force serves as external force for returning and rotating the torque transfer portion 500.

Three connection legs 251 formed at a connection member 250 to be described later may pass through the three guide slots 201a including the first guide slot. In this case, the bending portions 132 may be located at both sides of the associated connection leg 251 passing through the first guide slot. The connection legs 251 passing through the respective guide slots 201a may be guided to move in the longitudinal directions of the guide slots 201a. Since the connection legs 251 move only by fixed lengths of the respective guide slots 201a, it is possible to limit an angle of rotation of the connection member 250.

The flange portion 203 may have a plurality of fastening holes 203a so as to be fixed to the seat cushion 10.

The housing 200 may be made of any material. However, a relatively large load may act on the housing 200 since an inner peripheral surface of the housing 200 serves as a wedge friction surface with respect to a roller assembly 630 which may be included in a brake means 600 to be described later. With this point in view, the housing 200 may be manufactured, for example, by press processing a plate made of metal material and be heat treated to have certain stiffness.

The lever bracket 100 may be coupled to the front surface of the housing 200. The lever bracket 100 may be connected to a handle lever 20 (see FIG. 1) rotated by operation of a seat occupant. The lever bracket 100 may rotate along with rotation of the handle lever 20, and rotational force of the lever bracket 100 may be transferred to a clutch shaft 300 to be described later.

The lever bracket 100 may be rotatably coupled to the front surface of the housing 200. The lever bracket 100 may include, for example, a bracket body 101 and a bracket leg 104 as illustrated in the drawings. In the drawings, the bracket body 101 may be arranged so as to be overlapped with the front surface of the body portion 201. The bracket body 101 may have the coupling hole 102 formed at a center thereof such that the shaft coupling portion 202 passes through the coupling hole 102. The shaft coupling portion 202 is coupled to the coupling hole 102, thereby enabling the lever bracket 100 to be rotatably supported by the shaft coupling portion 202.

Three leg slots 103 may be formed on the bracket body 101 while being circumferentially spaced apart from each other about the coupling hole 102. The connection legs 251 may be coupled through the leg slots 103, and thus the connection member 250 and the lever bracket 100 may integrally rotate. In this case, since the angle of rotation of the connection member 250 is limited as described above, an angle of rotation of the lever bracket 100 may also be limited.

The bracket leg 104 may be configured of a pair of bracket legs bent from an outer peripheral surface of the bracket body 101.

First, it is necessary to return and rotate the lever bracket 100 such that the handle lever 20 is returned and rotated when the operation of the handle lever 20 by the occupant is completed. An elastic means for providing elastic force to the lever bracket 100 may be used to return and rotate the lever bracket 100. The elastic means, for example, may be an annular return spring 160 illustrated in the drawings.

The return spring 160 may be coupled to the front of the body portion 201. Inside surfaces of the pair of bracket legs 104 may respectively come into contact with outside surfaces of a pair of bent portions 161 formed at both end portions of the return spring 160 so as to be supported thereby.

The pair of bent portions 161 may be supported by a pair of stopper portions 204 protruding forward from the front surface of the body portion 201 such that a gap between the bent portions 161 is not increased any more.

When the lever bracket 100 rotates in a state in which the bracket legs 104 come into contact with the bent portions 161, any one of the bent portions 161 may move to the other thereof while being pressed by the associated bracket leg 104. In this case, the return spring 160 may generate restoring force, and the restoring force may serve as external force for returning and rotating the lever bracket 100.

Meanwhile, any one of the above-mentioned components accommodated in the housing 200 may be, for example, a clutch means. The clutch means may serve to transfer power input from the outside, for example, rotational force input by the operation of the handle lever 20 to the link means of the seat cushion 10.

As the clutch means which may be included in the components, various clutch means may be applied, such as the clutch means having a specific example described below and the known clutch means included in the pumping device.

In the drawings, the clutch means may include a clutch shaft 300, a clutch drum 400, and a torque transfer portion 500.

The clutch shaft 300 may be accommodated in the housing 200, and be rotated by rotational force transferred from the lever bracket 100 together with the lever bracket by an angle of rotation of the lever bracket 100. The rotational force of the clutch shaft 300 may be transferred to the clutch drum 400 to be described later.

The clutch shaft 300 may be connected to the lever bracket 100 in order to transfer rotational force from the lever bracket 100 to the clutch shaft 300. The clutch shaft 300 may be directly connected to the lever bracket 100, or may also be connected to the lever bracket 100 through the connection member 250 as illustrated in the drawings.

In the drawings, the clutch shaft 300 may have a spline portion 301 protruding forward from the front surface thereof so as to be coupled to the connection member 250. The spline portion 301 may have a spline formed on an outer peripheral surface thereof.

The connection member 250 may be arranged in front of the clutch shaft 300, and have a spline-shaped spline hole 252 formed at a center thereof such that the spline portion 301 is coupled to the spline hole 252. The clutch shaft 300 may integrally rotate with the connection member 250 by coupling the spline portion 301 to the spline hole 252 of the connection member 250.

The connection member 250 may have the three connection legs 251 which are bent from the outer peripheral surface thereof and extend forward. The connection legs 251 may pass through the guide slots 201a to be coupled though the leg slots 103 of the lever bracket 100. The connection member 250 is coupled to the lever bracket 100, thereby enabling the lever bracket 100 to rotate along with the clutch shaft 300.

The spline portion 301 of the clutch shaft 300 may have an insertion hole 303 formed at a center thereof such that the tip portion of the output shaft 620 passes through the insertion hole 303. The clutch shaft 300 may have a plurality of cam surfaces 302 formed on the outer peripheral surface thereof, and the cam surfaces 302 are continuously formed at regular intervals in the circumferential direction. Each of the cam surfaces 302 may be a concave curved surface or have a planar shape.

The clutch drum 400 may be accommodated in the housing 200, and be rotated by the rotational force transferred from the clutch shaft 300. The rotation force of the clutch drum 400 may be transferred to the output shaft 620 and the output shaft 620 transfers power to the link means of the seat cushion 10, thereby enabling a height of the seat cushion 10 to be adjusted.

The clutch drum 400 may include, for example, a drum portion 401 having a drum shape as illustrated in the drawings. The drum portion 401 may have a through-hole 402 formed at a center thereof such that the tip portion of the output shaft 620 passes through the through-hole 402. The clutch drum 400 may be accommodated in the housing 200. In this case, the clutch shaft 300 is inserted toward the opened front of the drum portion 401, and may be arranged at a center in an inside space of the clutch drum 400. In this case, a gap is circumferentially generated between the inner peripheral surface of the drum portion 401 and the outer peripheral surface of the clutch shaft 300, and the torque transfer portion 500 may be disposed at the gap.

The drum portion 401 may have a flange portion 403 which extends radially from the front outer periphery thereof. The flange portion 403 may have clutch legs 404 bent rearward from the outer periphery thereof.

The torque transfer portion 500 may serve to transfer the rotational force of the clutch shaft 300 to the clutch drum 400. The torque transfer portion 500, for example, may be provided with a plurality of adjacent fitting pieces 501. The torque transfer portion 500 may have an arc shape as a whole, and the fitting pieces 501 located at both end portions of the torque transfer portion 500 may be spaced apart from each other.

The respective fitting pieces 501 may be arranged on the cam surfaces 302 formed on the outer peripheral surface of the clutch shaft 300 in one-to-one correspondence manner. In a state in which the torque transfer portion 500 is interposed between the outer peripheral surface of the clutch shaft 300 and the inner peripheral surface of the clutch drum 400, the torque transfer portion 500 may generate friction force between the clutch shaft 300 and the fitting pieces 501 and between the fitting pieces 501 and the clutch drum 400. In more detail, the torque transfer portion 500 may generate friction force between the cam surfaces 302 and the fitting pieces 501 and between the fitting pieces 501 and the inner peripheral surface of the drum portion 401. Through such friction force, the rotational force of the clutch shaft 300 may be transferred to the clutch drum 400.

Meanwhile, the above-mentioned components accommodated in the housing 200 may further include a brake means in addition to the clutch means. The brake means has a function of selectively restricting the link means of the seat cushion 10 such that the link means is not moved when the link means completes the height adjustment of the seat cushion 10 by the rotational force transferred from the outside.

As the brake means for performing the above function, various brake means may be applied, such as the brake means having a specific example described below and the known brake means included in the pumping device.

As a specific example of the brake means, there is proposed a brake means including a brake wedge 610, an output shaft 620, and a roller assembly 630.

The brake wedge 610 has a drum shape in which the front thereof is opened. The drum portion 401 of the clutch drum 400 may be accommodated in the brake wedge 610. In this case, an outside portion of the brake wedge 610 may be inserted into a space between the outer peripheral surface of the drum portion 401 and inside surfaces of the clutch legs 404.

The brake wedge 610 may have wedge bosses 611 protruding radially from an outer peripheral surface thereof. When the clutch drum 400 engages with the brake wedge 610, the clutch legs 404 may be located between the wedge bosses 611.

The output shaft 620 may serve to finally transfer rotational force transferred from the clutch drum 400 to the link means of the seat cushion 10.

The output shaft 620 may include a first shaft 621 which is rotatably coupled to the shaft coupling portion 202 of the housing 200 while sequentially passing through the brake wedge 610, the clutch drum 400, and the clutch shaft 300.

The output shaft 620 may include a second shaft 622 which is formed continuously behind the first shaft 621 and is rotatably coupled through a shaft coupling portion 701 of a cover plate 700 to be described later. In addition, the output shaft 620 may include a third shaft 623 which is formed continuously behind the second shaft 622 and extends rearward from the cover plate 700.

In this case, the first shaft 621 may have a first spline shaft 624 formed at one side thereof. The brake wedge 610 may have a spline hole 614 which is formed at a center thereof and corresponds to the first spline shaft 624. The output shaft 620 may rotate along with the brake wedge 610 by coupling the first spline shaft 624 to the spline hole 614.

The third shaft 623 may have a second spline shaft 625 which is formed at one side thereof to transfer power to the link means of the seat cushion 10.

The roller assembly 630 may be interposed between the outer peripheral surface of the brake wedge 610 and the inner peripheral surface of the housing 200, and may generate friction force so as to restrict rotation of the brake wedge 610.

Specifically, the roller assembly 630 may be configured of a plurality of roller assemblies, each including a pair of rollers 631 and a roller spring 632 for providing elastic force such that the rollers 631 are away from each other when being closed to each other while connecting the rollers 631.

The roller spring 632 may be arranged to surround the associated wedge boss 611. The pair of rollers 631 may come into contact with the outer peripheral surface of the brake wedge 610 while being located such that the wedge boss 611 is interposed therebetween.

Meanwhile, the brake wedge 610 may be formed with roller location surfaces 612 formed on the outer peripheral surface thereof for insertion of the associated rollers 631 being interposed between the associated wedge bosses 611. Restraint section surfaces 613, which protrude radially from the outer peripheral surface of the brake wedge 610, may be formed between the associated roller location surfaces 612. The clutch legs 404 may be located so as to face the respective restraint section surfaces 613 between the wedge bosses 611.

The restraint section surfaces 613 allow a distance between the inner peripheral surface of the housing 200 and the outer peripheral surface of the brake wedge 610 to be reduced. Accordingly, when the rollers 631 are located to come into contact with the restraint section surfaces 613, strong friction force may be generated between the rollers 631 and the outer peripheral surface of the brake wedge 610 and between the rollers 631 and the inner peripheral surface of the housing 200, and thus rotation of the brake wedge 610 may be restricted. At the same time, rotation of the output shaft 620 may also be restricted.

However, when the rollers 631 are moved to the roller location surfaces 612, a gap may be formed between the rollers 631 and the outer peripheral surface of the brake wedge 610 and between the rollers 631 and the inner peripheral surface of the housing 200, and thus the brake wedge 610 may freely rotate.

When each clutch leg 404 rotates along with rotation of the clutch drum 400, the clutch leg 404 may push the roller 631 coming into contact therewith in the rotation direction and move the roller 631 to the associated roller location surface 612. In addition, the other rollers 631 which are beyond the wedge bosses 611 may be moved to the associated roller location surfaces 612 by the friction force.

In other words, the pair of rollers 631 may be close to each other by overcoming the elastic force of the roller spring 632 so as to be moved to the associated roller location surfaces 612, and thus the rotation restriction of the brake wedge 610 may be released. When the clutch legs 404 continue to push the rollers 631 by continuous rotation of the clutch drum 400, the brake wedge 610 rotates along with the clutch drum 400 and at the same time the output shaft 620 rotates together.

When reverse input torque acts when the height adjustment of the seat cushion 10 is completed and the rotation of the clutch drum 400 is stopped, the rollers 631 come into contact with the restraint section surfaces 613 as long as the rollers 631 are not pushed by the clutch legs 404, thereby generating strong friction force. Consequently, the brake wedge 610 may be maintained in a state in which the rotation thereof is restricted.

Meanwhile, the cover plate 700 may be coupled to the opened rear of the housing 200 so as to cover the inner portion of the housing 200. The cover plate 700 may have various shapes. For example, the cover plate 700 may have a disc shape and may have a shaft coupling portion 701 formed at a center thereof such that the second shaft 622 is rotatably coupled through the shaft coupling portion 701, as illustrated in the drawings.

The cover plate 700 may be inserted in and coupled to the opened rear of the housing 200. When the housing 200 has a cylindrical shape and the cover plate 700 has a disc shape as illustrated in the drawings, the cover plate 700 may have an outer diameter which is equal to or less than an inner diameter of the rear of the housing 200 such that the cover plate 700 is inserted in the opened rear of the housing 200. Preferably, the cover plate 700 may have an outer diameter equal to the inner diameter of the rear of the housing 200 so as not to generate a gap between the housing 200 and the cover plate 700.

Large forces acting outward of the housing 200 from the inner portion of the housing 200 may be applied to the housing 200 according to operation of the components accommodated in the housing 200. For example, when reverse input torque is applied to the output shaft 620 from the link means when the brake means is accommodated in the housing 200, significant forces F are radially applied to the inner peripheral surface of the housing 200 due to strong friction force by the roller assembly 630, as illustrated in FIG. 4. Consequently, the housing 200 may be deformed due to an increase of the inner diameter of the rear of the housing 200.

By such deformation, the components which are operatively accommodated in the housing 200 may malfunction. Specifically, friction force generated by the roller assembly 630 may be reduced due to the deformation of the housing 200, and thus the rotation restriction of the brake wedge 610 may not be properly performed. As a result, the operation restriction of the link means may not be properly performed.

Accordingly, the cover plate 700 in the embodiment may be coupled to the housing 200 by welding a rear edge of the cover plate 700 to the inner peripheral surface of the housing 200, so as not to generate the above deformation. In this case, the welding may be performed, for example, by a laser welding method.

The welding may be performed on the entirety of the edge of the cover plate 700 while a circle is described along the edge of the cover plate 700.

In addition, the welding may also be performed on only partial edge portions spaced along the edge of the cover plate 700, in consideration of manufacturing time and convenience. In this case, the spaced welded portions, namely, cover plate portions 700a coupled to the housing 200 by welding may be formed at positions facing each other in the radial direction of the cover plate 700. When both forces F act on the inner peripheral surface of the housing 200 in the radial direction thereof as described above, the welded portions 700a are formed to face each other in the radial direction, thereby enabling the housing 200 to be securely supported against the both forces.

Portions of the housing 200 to which the cover plate 700 is welded and coupled through the above welding are securely supported by the cover plate 700, thereby enabling the deformation of the housing 200 to be prevented.

Meanwhile, although the structure in which the cover plate 700 is inserted in the opened rear of the housing 200 so as to be welded and coupled to the housing 200 has been described in the embodiment, the present invention is not limited thereto.

Of course, various welding and coupling methods such as a method of welding and coupling the cover plate 700 to the housing 200 in a state in which an edge portion of the cover plate 700 is overlapped with the flange portion 203 of the housing 200 may be applied to the present invention.

Various embodiments have been described in the best mode for carrying out the invention. Although the present invention has been described with respect to the illustrative embodiments, it will be apparent to those skilled in the art that various variations and modifications may be made without departing from the spirit and scope of the invention as defined in the following claims.

Simple variations and modifications of the present invention belong to the scope of the present invention, and the specific protection scope thereof will be apparent by the appended claims.

### INDUSTRIAL APPLICABILITY

In accordance with the present invention, a housing may be securely supported against radial forces acting on an inner peripheral surface of the housing, by welding and coupling a cover plate to the housing. Consequently, deformation of the housing may be prevented even though the housing has a thin thickness, and thus a pumping device may have improved durability.

1. A pumping device for a vehicle seat, comprising:
a housing accommodating components therein, the components transferring a power to a link means for adjusting a height of a seat cushion; and
a cover plate welded and coupled to an opened rear of the housing.

2. The pumping device according to claim 1, wherein the cover plate is coupled to the housing in such a manner that the cover plate is inserted in the opened rear of the housing and welding is performed between an edge of the cover plate and an inner peripheral surface of the housing.

3. The pumping device according to claim 2, wherein the cover plate has an outer diameter which is equal to an inner diameter of the opened rear of the housing.

4. The pumping device according to claim 2, wherein the welding is performed on the entirety of the edge of the cover plate.

5. The pumping device according to claim 2, wherein the welding is performed on portions spaced along the edge of the cover plate.

6. The pumping device according to claim 5, wherein the spaced welded portions are formed at positions facing each other in a radial direction of the cover plate.

7. The pumping device according to claim 1, wherein the welding is performed by a laser welding method.
